(19) United States
(12) Patent Application Publication
(10) Pub. No.: US 2018/0194117 A1
(43) Pub. Date: Jul. 12, 2018

(54) Multilayer polymer film and multipack made thereof

(71) Applicant: Klöckner Pentaplast GmbH, Heiligenroth (DE)

(72) Inventors: Jordi GARRIGA, Sant Celoni (BCN) (ES); Nicolas QUILLAY, Languidic (FR); Carles IBAÑEZ, Terrassa (BCN) (ES)

(73) Assignee: KLOCKNER PENTAPLAST GMBH, Heiligenroth (DE)

(21) Appl. No.: 15/741,702

(22) PCT Filed: Jul. 5, 2016
(86) PCT No.: PCT/EP2016/001145

§ 371 Date: Jan. 3, 2018

(30) Foreign Application Priority Data
Jul. 7, 2015 (DE) 10 2015 008 554.9

(51) Int. Cl. B32B 27/08; B32B 5/18; B32B 27/06; B32B 27/18; B32B 27/36; B32B 27/32; B32B 27/30; B65D 1/40

(52) U.S. Cl. CPC B32B 27/08; B32B 2439/40; B32B 27/065; B32B 27/18; B32B 27/36; B32B 27/32; B32B 27/306; B65D 1/40; B32B 2250/24; B32B 2266/0264; B32B 2307/7244; B32B 2307/7246; B32B 2307/746; B32B 2439/70; B32B 5/18

(57) ABSTRACT

A multilayer polymer film for multipacks is provided that includes at least two layers formed from polyester and additives, in which a first layer is porous and a second layer contains an inorganic filler. Multipacks thermoformed from the multilayer polymer film are equipped with snap incisions.

The present invention pertains to a multilayer polymer film with 2 to 10 layers and to a multipack comprising 2 to 40 containers, which is thermoformed from the multilayer polymer film.

Multipacks for food produce, such as yoghurt, pudding, jam or butter are known in the art. Customary multipacks comprising 2 to 40 packs, respectively containers or cups are thermoformed from white or colored single-layer polystyrene film having a thickness of 400 to 1200 μm. Typically, the containers of a multipack are arranged in a pattern of periodic rows and columns connected by planar strips of polystyrene film. The respective food produce may be filled into the containers of a multipack immediately after thermoforming (inline) or after intermediate storage of empty multipacks (offline). Subsequently, the multipack, respectively the containers holding the food produce are sealed with a lid film. Thereafter, the lid film and the surface of contiguous multipack strips extending between adjacent container rows and columns are incised to a preset depth using a cutting wheel or similar means in order to facilitate manual separation of individual containers by end consumers. In the art as well as in the present invention said incisions are also termed as “snap incisions”.

A polymer film suitable for the manufacture of multipacks must be thermoformable and sealable and provide adequate mechanical stability and diffusion barrier in order to prevent mechanical damage and preserve the food produce contained therein over an extended time period. Furthermore, the film material must not release harmful substances when directly contacting food produce over an extended time period.

Customary multipacks are manufactured from homogeneous single-layer film on the basis of polystyrene. Polystyrene provides suitable thermal and mechanical properties at a favorable density of 0.96 to 1.04 g/cm³. However, polystyrene is known to have a low diffusion barrier for oxygen and water vapor, which in many instances can adversely affect food produce stored in polystyrene containers over an extended time period.

Furthermore, polystyrene contains up to 1% by weight of the lipid-soluble monomer styrene which migrates into food produce and can adversely affect human health (cf. J. R. Withey “Quantitative Analysis of Styrene Monomer in Polystyrene and Foods Including Some Preliminary Studies of the Uptake and Pharmacodynamics of the Monomer in Rats” Environmental Health Perspectives, Vol. 17, pp. 125-133, 1976).

Thus, there exists a need for a polymer film that does not pose a health risk, is suitable for multipacks and provides improved shelf life for food produce.

Accordingly, the present invention has the objective to provide a thermoformable film for the manufacture of multipacks with improved diffusion barrier for oxygen and water vapour compared to conventional multipacks made from polystyrene in conjunction with suitable mechanical properties. In particular the inventive film, when thermoformed, should be resistant against bending and kinking under mechanical load as occurring during storage and transport of multipacks filled with food produce, such as yoghurt. Furthermore, the inventive multipack should provide easy separation of individual packs, respectively containers when equipped with snap incisions. This objective is achieved through a multilayer polymer film with 2 to 10 layers, wherein
a first layer consists of 80 to 99.5% by weight of polyester and 0.5 to 20% by weight of additives, based on the total weight of the first layer and comprises pores;
a second layer is bonded to a first surface of the first layer and consists of 50 to 90% by weight of polyester and 10 to 50% by weight of additives, wherein 1 to 30% by weight of a first additive is selected from chalc, talc, mica, wollastonite, calcium carbonate, bentonite, kaolin, clay, titanium oxide and mixtures thereof, based on the total weight of the second layer.

Advantageous implementations of the inventive film are characterized in that:
the multilayer polymer film has an oxygen permeability (oxygen transmission rate OTR) of 1 to 40 cm³/(m²·day·atm), measured according to DIN 53380-3;
the multilayer polymer film has a water vapor permeability (water vapor transmission rate WVTR) of 1 to 6 g/(m²·day), measured according to DIN EN ISO 15106-2;
the multilayer polymer film has an oxygen transmission rate of 1 to 10 cm³/(m²·day·atm), 1 to 5 cm³/(m²·day·atm), 3 to 7 cm³/(m²·day·atm) or 6 to 10 cm³/(m²·day·atm), measured according to DIN 53380-3;
the multilayer polymer film has a water vapor permeability (water vapor transmission rate WVTR) of 1 to 3 g/(m²·day), 1 to 2 g/(m²·day) or 2 to 3 g/(m²·day), measured according to DIN EN ISO 15106-2;
the multilayer polymer film has a bending stiffness of 60 to 200 N·mm² per 1 mm film width, measured according to DIN 53350;
the multilayer polymer film has a bending stiffness of 50 to 120 N·mm² per 1 mm film width, measured according to DIN 53350 at film thickness of 700 μm;
the multilayer polymer film has a bending stiffness of 50 to 70 N·mm², 60 to 80 N·mm², 70 to 90 N·mm², 80 to 100 N·mm², 90 to 110 N·mm² or 100 to 120 N·mm² per 1 mm film width, measured according to DIN 53350 at film thickness of 700 μm;
the multilayer polymer film has a bending stiffness of 146·t³ to 350·t³ N/mm per 1 mm film width, wherein t is the thickness of the multilayer polymer film in units of mm and the bending stiffness is measured according to DIN 53350;
the multilayer polymer film has a bending stiffness of 146·t³ to 204·t³ N/mm, 175·t³ to 233·t³ N/mm, 204·t³ to 262·t³ N/mm, 233·t³ to 292·t³ N/mm, 262·t³ to 321·t³ N/mm or 292·t³ to 350·t³ N/mm per 1 mm film width, wherein t is the thickness of the multilayer polymer film in units of mm and the bending stiffness is measured according to DIN 53350;
the multilayer polymer film has a density of 1 to 1.4 g/cm³;
the multilayer polymer film has a density of 1 to 1.2 g/cm³, 1.1 to 1.3 g/cm³ or 1.2 to 1.4 g/cm³;
the multilayer polymer film is made by coextrusion, wherein multiple melt streams are overlayed and extruded through a coextrusion slit die;
the first layer is formed by extrusion or coextrusion of a plastified mold composition containing a pressurized gas and pores in the first layer are generated through expansion of the pressurized gas;
the first layer is formed by extrusion or coextrusion of a plastified mold composition containing a foaming agent and pores in the first layer are generated through expansion of a gas created by volatilization of the foaming agent;
the first layer consists of 80 to 99.5% by weight of polyester and 0.5 to 20% by weight of additives, based on the total weight of the first layer, comprises pores and the additives are selected from processing aids, heat stabilizers, lubricants, waxes, fats, paraffins, epoxidized soya oil, polymeric modifiers, acrylate-based polymers, butyl-methacrylate-based polymers, methacrylate-butyl-styrene-based polymers, methacrylate-butadiene-styrene-based polymers, methylmethacrylate-butadiene-styrene-based polymers, dyes and pigments, fungicides, UV stabilizers, fire-protection agents and fragrances;
the multilayer polymer film is not stretched;
the multilayer polymer film is stretched in a first direction or in a first and second direction at a stretch ratio of 1.01 to 1.5 in the first and/or second direction independently from each other;
the first layer is not stretched;
the first layer is stretched in a first direction or in a first and second direction at a stretch ratio of 1.01 to 1.5 in the first and/or second direction independently from each other;
the first layer consists of 80 to 99.5% by weight of polyester and 0.5 to 20% by weight of additives, based on the total weight of the first layer, comprises pores and has an elastic modulus of 700 to 2000 N/mm², when prepared as single-layer film under the same conditions as the multilayer polymer film;
the second layer is bonded to a first surface of the first layer and consists of 50 to 90% by weight of polyester and 10 to 50% by weight of additives, wherein 1 to 30% by weight of a first additive is selected from chalc, talc, mica, wollastonite, calcium carbonate, bentonite, kaolin, clay, titanium oxide and mixtures thereof, based on the total weight of the second layer and further additives are selected from processing aids, heat stabilizers, lubricants, waxes, fats, paraffins, epoxidized soya oil, polymeric modifiers, acrylate-based polymers, butyl-methacrylate-based polymers, methacrylate-butyl-styrene-based polymers, methacrylate-butadiene-styrene-based polymers, methylmethacrylate-butadiene-styrene-based polymers, dyes and pigments, fungicides, UV stabilizers, fire-protection agents and fragrances;
the second layer is bonded to a first surface of the first layer and consists of 50 to 90% by weight of polyester and 10 to 50% by weight of additives, wherein 1 to 30% by weight of a first additive is selected from chalc, talc, mica, wollastonite, calcium carbonate, bentonite, kaolin, clay, titanium oxide and mixtures thereof, based on the total weight of the second layer and has an elastic modulus of 1800 to 3200 N/mm², when prepared as single-layer film under the same conditions as the multilayer polymer film;
the first layer has an elastic modulus of 700 to 1000 N/mm², 800 to 1200 N/mm², 1000 to 1400 N/mm², 1200 to 1600 N/mm², 1400 to 1800 N/mm² or 1600 to 2000 N/mm², when prepared as single-layer film under the same conditions as the multilayer polymer film;
the second layer has an elastic modulus of 1800 to 2200 N/mm², 2000 to 2400 N/mm², 2200 to 2600 N/mm², 2400 to 2800 N/mm², 2600 to 3000 N/mm² or 2800 to 3200 N/mm², when prepared as single-layer film under the same conditions as the multilayer polymer film;
the one or more polyesters of the first and second layer independently from each other are selected from polyethylene terephthalate and polyesters which consist of (i) 80 to 100 mol-% of a diacid residue component selected from terephthalic acid, naphthalene dicarboxylic acid, 1,4-cyclohexanedicarboxylic acid, isophthalic acid and mixtures thereof and (ii) 80 to 100 mol-% of a diol residue component selected from diols containing 2 to 10 carbon atoms, in particular ethylene glycol, and mixtures thereof and 0 to 20 mol-% of a modifying diol selected from 1,3-propanediol, 1,4-butanediol, 1,5-pentanediol, 1,6-hexanediol, 1,8-octanediol, 1,4-cyclohexanedimethanol, 2,2,4-trimethyl-1,3-pentanediol, propylene glycol, 2,2,4,4-tetramethyl-1,3-cyclobutanediol, based on 100 mol-% diacid residues and, respectively 100 mol-% diol residues;
the multilayer polymer film has a thickness of 400 to 1200 μm;
the multilayer polymer film has a thickness of 400 to 800 μm, 600 to 1000 μm or 800 to 1200 μm;
the ratio of thickness T1 of the first layer to thickness T2 of the second layer is in the range from 0.5 to 4, i.e. 0.5≤T1/T2≤4;
the ratio of thickness T1 of the first layer to thickness T2 of the second layer is in the range from 0.5 to 2, i.e. 0.5≤T1/T2≤2;
the ratio of thickness T1 of the first layer to thickness T2 of the second layer is in the range from 1 to 2, i.e. 1≤T1/T2≤2;
the ratio of thickness T1 of the first layer to thickness T2 of the second layer is in the range from 1.5 to 2.5, i.e. 1.5≤T1/T2≤2.5;
the ratio of thickness T1 of the first layer to thickness T2 of the second layer is in the range from 2 to 3, i.e. 2≤T1/T2≤3;
the ratio of thickness T1 of the first layer to thickness T2 of the second layer is in the range from 2.5 to 3.5, i.e. 2.5≤T1/T2≤3.5;
the ratio of thickness T1 of the first layer to thickness T2 of the second layer is in the range from 3 to 4, i.e. 3≤T1/T2≤4;
the ratio of thickness T1 of the first layer to thickness T2 of the second layer is in the range from 0.5 to 0.9, i.e. 0.5≤T1/T2≤0.9;
the first layer comprises pores and has a density of 0.8 to 1.1 g/cm³, when prepared as single-layer film under the same conditions as the multilayer polymer film;
the first layer comprises pores and has a density of 0.8 to 1 g/cm³ or 0.9 to 1.1 g/cm³, when prepared as single-layer film under the same conditions as the multilayer polymer film;
the second layer has a density of 1.3 to 1.5 g/cm³, when prepared as single-layer film under the same conditions as the multilayer polymer film;
the second layer has a density of 1.3 to 1.4 g/cm³ or 1.4 to 1.5 g/cm³, when prepared as single-layer film under the same conditions as the multilayer polymer film;
the first layer comprises 8 to 19.9% by weight of polyethylene and 0.1 to 2% by weight of ethylene vinyl acetate, based on the total weight of the first layer;
the second layer comprises 8 to 24% by weight of polyethylene and 0.1 to 2% by weight of ethylene vinyl acetate, based on the total weight of the second layer;
the first layer comprises 0.01 to 1% by weight of a foaming agent, based on the total weight of the first layer;
the foaming agent is selected from carbon dioxide, sodium hydrogen carbonate and citric acid, nitrogen, azodicarbonamide, oxy-bis-benzene sulfonylhydrazide, toluene sulfonylhydrazide, benzene sulfonylhydrazide, toluene sulfonylsemicarbazide, 5-phenyltetrazole, di-nitroso pentamethylene tetramine and mixtures thereof,
the second layer comprises 1 to 30% by weight of an additive selected from chalc, talc, mica, wollastonite, calcium carbonate, bentonite, kaolin, clay, titanium oxide and mixtures thereof, based on the total weight of the second layer, said additive consisting of particles having a particle size of less than 60 μm, from 0.01 to 50 μm, 0.01 to 40 μm, 0.01 to 30 μm or 1 to 50 μm;
the second layer comprises 1 to 8% by weight, 6 to 10% by weight, 8 to 12% by weight, 10 to 14% by weight, 12 to 16% by weight, 14 to 18% by weight, 16 to 20% by weight, 18 to 22% by weight, 20 to 24% by weight, 22 to 26% by weight, 24 to 28% by weight or 26 to 30% by weight of an additive selected from chalc, talc, mica, wollastonite, calcium carbonate, bentonite, kaolin, clay, titanium oxide and mixtures thereof, based on the total weight of the second layer;
the multilayer polymer film consists of 3 layers;
the multilayer polymer film consists of 4 layers;
the multilayer polymer film comprises a third layer bonded to a second surface of the first layer opposite to the second layer, the third layer consisting of 90 to 99.5% by weight of polyester and 0.5 to 10% by weight of additives, based on the total weight of the third layer;
the multilayer polymer film comprises a third layer bonded to a second surface of the first layer opposite to the second layer, the third layer consisting of 90 to 99.5% by weight of polyester and 0.5 to 10% by weight of additives, based on the total weight of the third layer, and the third layer does not comprise a foaming agent;
the multilayer polymer film comprises a third layer bonded to a second surface of the first layer opposite to the second layer, the third layer consisting of 90 to 99.5% by weight of polyester and 0.5 to 10% by weight of additives, based on the total weight of the third layer, and the third layer does not comprise anorganic particles;
the multilayer polymer film comprises a fourth layer bonded to a surface of the second layer opposite to the first layer, the fourth layer comprising 90 to 99.5% by weight of polyester and 0.5 to 10% by weight of additives, based on the total weight of the fourth layer;
the multilayer polymer film comprises a fourth layer bonded to a surface of the second layer opposite to the first layer, the fourth layer comprising 90 to 99.5% by weight of polyester and 0.5 to 10% by weight of additives, based on the total weight of the fourth layer, and the fourth layer does not comprise a foaming agent;
the multilayer polymer film comprises a fourth layer bonded to a surface of the second layer opposite to the first layer, the fourth layer comprising 90 to 99.5% by weight of polyester and 0.5 to 10% by weight of additives, based on the total weight of the fourth layer, and the fourth layer does not comprise anorganic particles;
the one or more polyesters of the third and fourth layer independently from each other are selected from polyethylene terephthalate and polyesters which consist of (i) 80 to 100 mol-% of a diacid residue component selected from terephthalic acid, naphthalene dicarboxylic acid, 1,4-cyclohexanedicarboxylic acid, isophthalic acid and mixtures thereof and (ii) 80 to 100 mol-% of a diol residue component selected from diols containing 2 to 10 carbon atoms, in particular ethylene glycol, and mixtures thereof and 0 to 20 mol-% of a modifying diol selected from 1,3-propanediol, 1,4-butanediol, 1,5-pentanediol, 1,6-hexanediol, 1,8-octanediol, 1,4-cyclohexanedimethanol, 2,2,4-trimethyl-1,3-pentanediol, propylene glycol, 2,2,4,4-tetramethyl-1,3-cyclobutanediol, based on 100 mol-% diacid residues and, respectively 100 mol-% diol residues;
the third layer has a thickness of 4 to 60 μm;
the third layer has a thickness of 4 to 20 μm, 10 to 30 μm, 20 to 40 μm, 30 to 50 μm or 40 to 60 μm; and/or
the fourth layer has a thickness of 4 to 60 μm.

Throughout the present invention—unless explicitly stated otherwise—the term “% by weight” refers to the total weight of the film layer under consideration, e.g. to the total weight of the first, second, third or fourth layer of the inventive multilayer polymer film, wherein the total weight of the film layer under consideration represents 100% by weight. The amount of a component in one of the film layers in units of “% by weight” corresponds to the amount of this component in the molding composition used for extrusion of the film layer, relative to the total weight of the molding composition.

Furthermore, the present invention has the objective to provide a multipack having improved diffusion barrier for oxygen and adequate diffusion barrier for water vapour compared to conventional multipacks made from polystyrene in conjunction with suitable mechanical properties. In particular the multipack should be resistant against bending and kinking under mechanical loads occurring for example, when twenty or more multipacks filled with food produce, such as jam or yoghurt are stacked upon each other. Furthermore, the inventive multipack should provide easy separation of individual packs, respectively containers when equipped with suitable incisions.

This objective is achieved through a multipack comprising 2 to 40 containers, wherein the multipack is thermoformed from the inventive multilayer film as described above and wherein the first layer or the third layer of the multilayer polymer film constitute an upper surface of the multipack having concave portions.

An advantageous implementation of the inventive multipack is characterized in that the multipack comprises 1 to 40 snap incisions extending from the upper surface of the multipack into the multilayer polymer film to a depth D, wherein D1≤D≤D2, D1 extends to 80% of the thickness of the first layer and D2 extends to 50% of the thickness of the second layer.

The snap incisions may be applied after the thermoformed multipack has been filled with produce and sealed with a lid film. Thus, the multipack of the present invention may also comprise a lid film sealed onto contiguous planar strips of the multipack extending between adjacent container rows and columns. Preferably, said lid film consists of a sealable single-layer or multilayer polymer film equipped with a metal coating and one or more print layers.

The inventive multilayer polymer film is prepared by known methods, such as coextrusion or calendering in conjunction with lamination. Similarly, the inventive multipack is manufactured using conventional thermoforming equipment and process parameters commensurate to those for multipacks made from polystyrene film.

The inventive multilayer polymer film may consist of two or three layers, i.e. the first and second layer plus optionally either the third or fourth layer.

Each of the layers of the inventive multilayer polymer film provides distinct functionality as explained hereafter.

The first layer is porous, has reduced density compared to regular polyethylene terephthalate and thus lowers the overall density and weight of the multilayer polymer film. Coincidentally, the first layer has a somewhat reduced elastic modulus and higher elongation at break which renders the multilayer polymer film more flexible and resistant against bending and tensile load. Also, due to its porosity the first layer can be easily cut and facilitates placement of snap incisions.

The second layer, which preferably contains a particulate inorganic additive, has a high elastic modulus compared to regular polyethylene terephthalate and imparts bending stiffness to the multilayer polymer film. In addition the second layer is brittle and furthers “snappability” of multipacks thermoformed from the inventive multilayer polymer film. The term “snappability” refers to the suitability of a multipack for manually induced breakage along designated snap incisions.

By adjusting the thickness and mechanical properties, particularly the elastic modulus of the first and second layer the bending stiffness and—in conjunction with snap incision depth—the snappability of the multilayer polymer film can be tuned to the application specific requirements for a multipack. Furthermore, the thickness of the first and second layer can also be adjusted in order to adapt the thickness of the multilayer polymer film to the specific requirement of a multipack thermoforming operation.

In an advantageous embodiment of the inventive multilayer polymer film the first and/or second layer comprises a polyolefin or a polyamide, preferably in conjunction with a compatibilizer such as ethylene vinyl acetate in order to increase the barrier against diffusion of oxygen and water vapor. The polyolefin or polyamide forms domains in the polyester matrix of the first and/or second layer and reduces the diffusivity of O₂- and H₂O-molecules.

The optional third layer provides a smooth nonporous surface finish and insulates food produce contained in a multipack from the first layer of the inventive multilayer polymer film. In addition the third layer increases the bending stiffness of the multilayer polymer film.

The optional fourth layer enhances the visual appearance of multipacks thermoformed from the inventive multilayer polymer film. Preferably, the outer surface of the fourth layer opposite to the second layer has a glossy surface finish. In addition the fourth layer may comprise color additives which preferably are compliant with the requirements for food packaging.

### BRIEF DESCRIPTION OF THE DRAWINGS

FIG. 1-3 are schematics of multilayer films of the present invention;

FIG. 4 shows a perspective view of a multipack made from the inventive film;

FIG. 5-8 show details of snap incisions in the multipack of the present invention;

FIG. 9 shows the geometry of the setup for measuring the bending stiffness of the inventive film.

### DETAILED DESCRIPTION

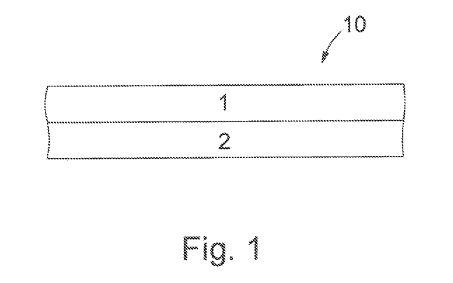

FIG. 1 shows a multilayer polymer film 10 according to the present invention comprising a first layer 1 and a second layer 2.

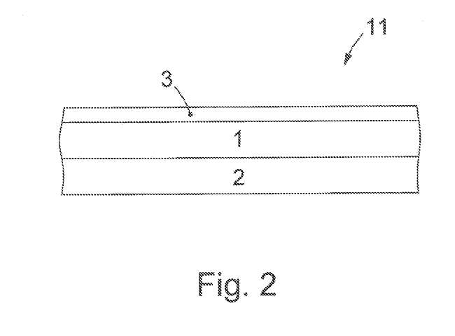

FIG. 2 shows a multilayer polymer film 11 according to the present invention comprising a first layer 1, a second layer 2 and a third layer 3.

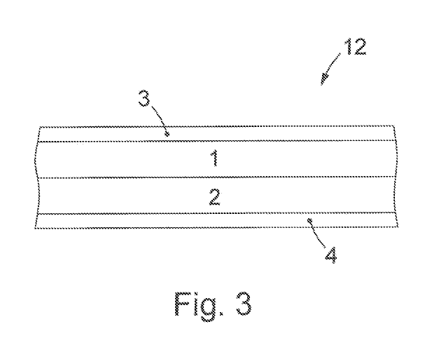

FIG. 3 shows a multilayer polymer film 13 according to the present invention comprising a first layer 1, a second layer 2, a third layer 3 and a fourth layer 4.

The inventive multilayer polymer film may consist of three layers, i.e. the first and second layer plus either the third or fourth layer. In particular the multilayer polymer film may consist of layers 1, 2 and 3 or layers 1, 2 and 4.

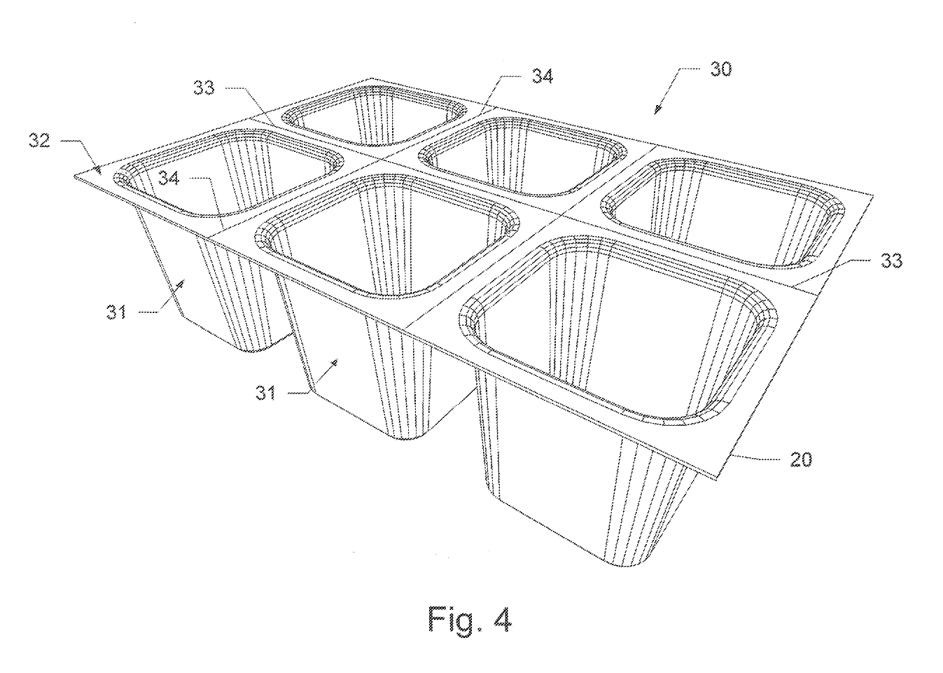

FIG. 4 shows a perspective view of an exemplary multipack 30 thermoformed from the multilayer polymer film of the present invention. The multipack 30 comprises six containers 31. Preferably, containers 31 are arranged in a periodic pattern of parallel rows and columns. An upper surface 32 of the multipack 30 comprises concave portions, the shape of which corresponds to the shape of containers 31. Preferably, the upper surface 32 is formed by the first layer or the third layer of the multilayer polymer film of the present invention. The upper surface 32 of multipack 30 further comprises incisions 33 and 34. Preferably, incisions 33 and 34 are located symmetrically halfway between adjacent rows and columns of containers 31.

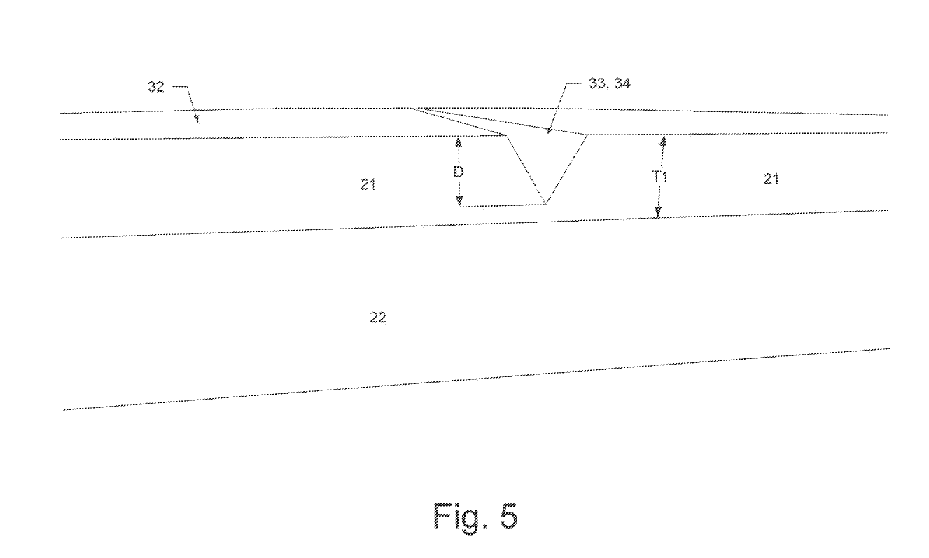

FIG. 5 schematically shows details of incisions 33 and 34 in the upper surface 32 of a multipack thermoformed from a film according to the present invention, wherein said film comprises a first layer 21 and a second layer 22, corresponding to layer 1 and, respectively layer 2 of FIG. 1. In FIG. 5 the thickness of the first layer 21 is designated by reference sign “T1”. Incisions 33 and 34 extend from the upper surface 32 into the first layer 21 down to depth D. Preferably, depth D is equal or larger than 60% of T1, i.e. D≥0.6×T1, and more preferably equal or larger than 80% of T1, i.e. D≥0.8×T1.

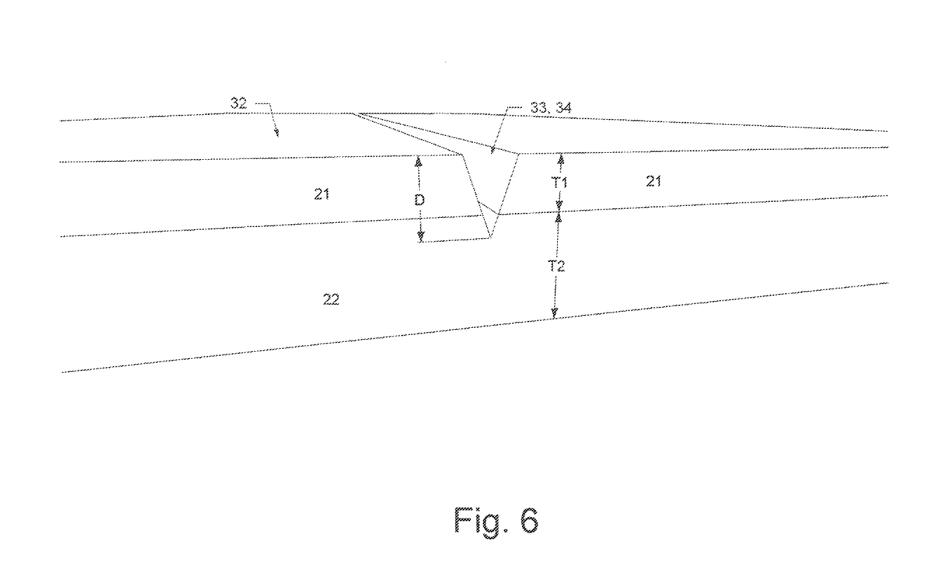

Similarly to FIG. 5, FIG. 6 shows incisions 33 and 34 with depth D in the upper surface 32 of a multipack thermoformed from a film according to the present invention, wherein said film comprises a first layer 21 and a second layer 22, corresponding to layer 1 and, respectively layer 2 of FIG. 1. Layer 21 and 22 have thickness T1 and, respectively T2. Incisions 33 and 34 extend through the first layer 21 into the second layer 22, preferably down to a depth D which corresponds to less or equal to 50% of thickness T2 of second layer 22, i.e. D≤T1+0.5×T2.

With reference to FIGS. 5 and 6, the depth D of incisions 33 and 34 is preferably bounded according to the following relation

0.6×T1≤D≤T1+0.5×T2

and more preferably, according to the relation

0.8×T1≤D≤T1+0.5×T2

Similarly to FIGS. 5 and 6, FIGS. 7 and 8 show incisions 33 and 34 with depth D in the upper surface 32 of a multipack thermoformed from a film according to the present invention, wherein said film comprises a first layer 21, a second layer 22 and a third layer 23, corresponding to layer 1, respectively layer 2 and, respectively layer 3 of FIGS. 2 and 3. Layer 21, 22 and 23 have thickness T1, respectively T2 and, respectively T3.

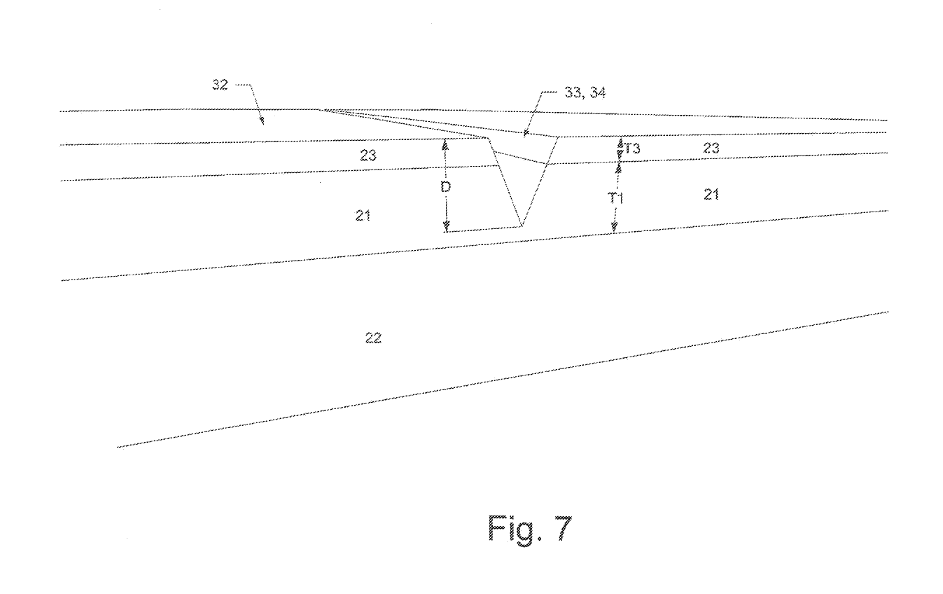

FIG. 7 shows incisions 33 and 34 extending through the third layer 23 into the first layer 21, preferably down to a depth D which corresponds to at least 60% of thickness T1 of first layer 21, i.e. D≥T3+0.6×T1, and more preferably at least 80% of thickness T1, i.e. D≥T3+0.8×T1.

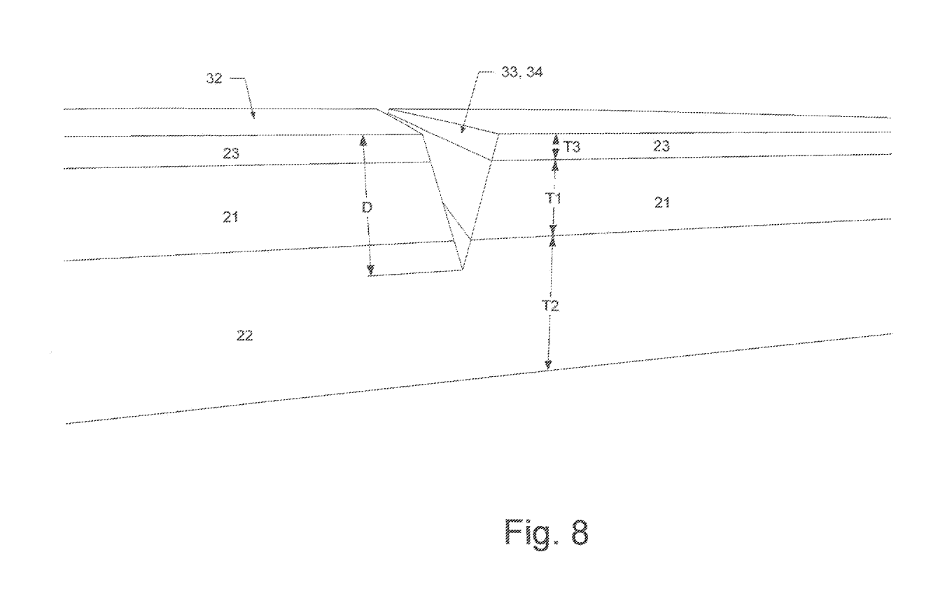

FIG. 8 shows incisions 33 and 34 extending through the third and first layer 23 and 21 into the second layer 22, preferably down to a depth D which is less or equal to 50% of thickness T2 of second layer 22, i.e. D≤T3+T1+0.5×T2.

With reference to FIGS. 7 and 8, the depth D of incisions 33 and 34 is preferably bounded according to the following relation

T3+0.6×T1≤D≤T3+T1+0.5×T2

and more preferably, according to the relation

T3+0.8×T1≤D≤T3+T1+0.5×T2

Despite not being shown in FIGS. 4, 5, 6, 7 and 8, the multipack 30 of the present invention may also comprise a lid film sealed onto contiguous planar strips of the multipack 30 extending between adjacent container rows and columns. Preferably, said lid film consists of a sealable single-layer or multilayer polymer film equipped with a metal coating and one or more print layers. Regardless of whether or not the inventive multipack 30 comprises a lid film, the above stated bounds for the depth D of snap incisions 33, 34 with respect to the upper surface 32 of multipack 30, formed by the first layer 21 or third layer 23 of the inventive multilayer polymer film, are implemented.

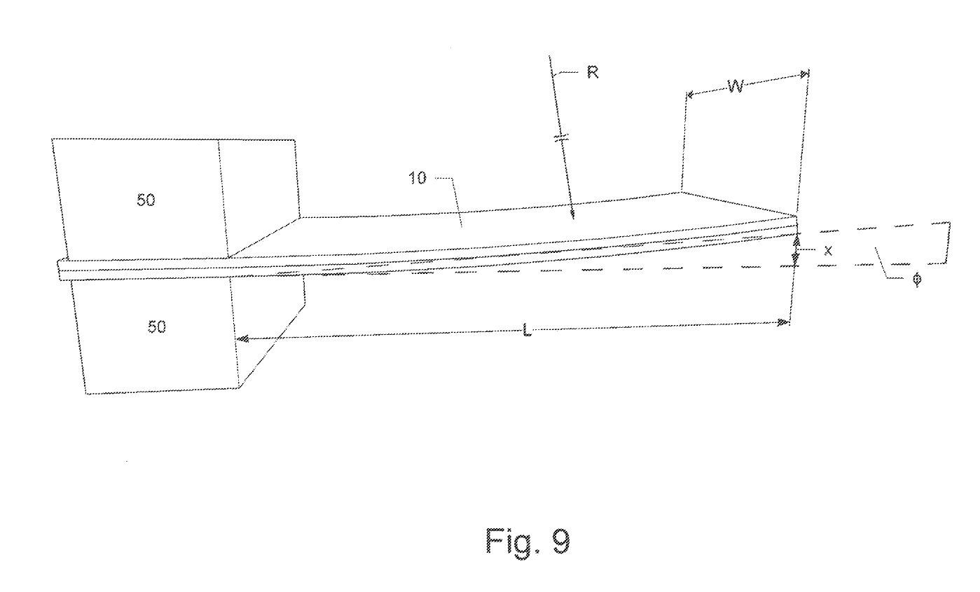

FIG. 9 shows a perspective schematic of the geometry for measurement of bending stiffness according to DIN 53350. A film sample 10 having width W is fixated at one end by a clamp 50. At distance L from clamp 50 the free standing end of film sample 10 is deflected in a direction perpendicular to the nominal film sample plane defined by clamp 50. In the present invention distance L, is also designated as bending length L.

The perpendicular deflection is designated by reference sign “x” and the corresponding deflection angle by “ϕ”, wherein ϕ=tan⁻¹(x/L). The deflection of film 10 is effected by an electronic actuator (not shown in FIG. 9) equipped with a load cell and a position transducer for measuring the bending force and corresponding deflection x. The bending stiffness S is defined as the ratio of bending moment M to curvature κ, i.e. S=M/κ, wherein curvature κ is the inverse of the bending radius R, i.e. κ=1/R. For small angular deflection ϕ≤7 degree (i.e. ϕ≤0.122 radian) the bending stiffness S can be approximated according to the formula S=F·L³/(3·x), wherein F designates the bending force.

In the present invention the bending stiffness is preferably measured using an automated instrument, such as 2-Point Bending Tester from Zwick Roell.

In the invention the bending stiffness S is stated in physical units of [N·mm² per 1 mm film width]. The physical bending stiffness of a film having a width of W in units of [mm] is then given by W×S. In scientific and technical literature, it is also common to state bending stiffness Ś in width normalized units of [N·mm]. The physical bending stiffness of a film having a width normalized bending stiffness Ŝ and a width of W in units of [mm], is then calculated as W×mm×Ŝ. Aside from differing units the numerical values of physical bending stiffness S [N·mm² per 1 mm film width] and width normalized bending stiffness Ŝ [N·mm] are identical.

### Inventive Example

A four-layer polymer film according to the present invention of type C/A/B/C was prepared using three extruders and a feedblock/die designed for overlay of four melt streams. The thickness and material composition of the four layers are listed beneath.

TABLE 1
Composition of inventive example film

| Layer | Layer | |
|---|---|---|
| no./type | thickness^{†} | Layer material |
| 3/C | 20 μm | 96.5 wt-% APET RAMAPET^{††} N180/ |
| | | 0.5 wt-% antiblock agent (wax + SiO₂ |
| | | Sukano T dc S479)/3 wt-% masterbatch |
| | | color (PET + white pigment) |
| 1/A | 265 μm | 97.5 wt-% BPET^{‡}/2 wt-% masterbatch |
| | | white (25 wt-% LDPE + 75 wt-% TiO₂)/ |
| | | 0.5 wt-% foaming agent (NaHCO₃ + citric |
| | | acid + nucleating agent) |
| 2/B | 395 μm | 68 wt-% BPET^{‡}/30 wt-% masterbatch |
| | | chalk (20 wt-% PPH + 80 wt-% CaCO₃ |
| | | particle size < 5 μm)/2 wt-% masterbatch |
| | | white (25 wt-% LDPE + 75 wt-% TiO₂) |
| 4/C | 20 μm | 96.5 wt-% APET RAMAPET^{††} N180/ |
| | | 0.5 wt-% antiblock agent (wax + SiO₂ |
| | | Sukano T dc S479)/3 wt-% masterbatch |
| | | color (PET + white pigment) |

^{†}nominal layer thickness based on amount and density of the respective layer material;
^{††}RAMAPET N180 having intrinsic viscosity of 0.8 dl/g;
^{‡}BPET consisting of 85 wt-% PET (50 wt-% post consume recycled PET + 50 wt-% APET RAMAPET N180), 13 wt-% LDPE with melt flow rate of 3 to 8 g/min and 2 wt-% ethylene vinyl acetate.

The thickness, density, bending stiffness, oxygen permeability (OTR) and water vapor permeability (WVTR) of the thus obtained four-layer polymer film were measured according to the methods recited in Table 4 and following results obtained:

TABLE 2
Inventive example film properties

| | |
|---|---|
| thickness | 695 μm |
| density | 1.28 g · cm⁻³ |
| bending stiffness | 104.7 N · mm² per 1 mm width |
| oxygen permeability | 7.4 cm³/(m² · day · atm) |
| water vapor permeability | 1.61 g/(m² · day) |

### Comparative Example

A commercially available white polystyrene film for thermoforming of multipacks was tested using the same measurement methods and conditions as in the inventive example. For thickness, density, oxygen permeability and water vapor permeability of the white polystyrene film the following results were obtained:

TABLE 3
Comparative example film properties

| | |
|---|---|
| thickness | 840 μm |
| density | 1.09 g · cm⁻³ |
| bending stiffness | 141.7 N · mm² per 1 mm width |
| oxygen permeability | 220.0 cm³/(m² · day · atm) |
| water vapor permeability | 3.80 g/(m² · day) |

The bending stiffness S of a film consisting of a homogeneous material is proportional to the elastic modulus E multiplied by the third power of the film thickness t, i.e. S˜E·t³. In order to compare the bending stiffness of the inventive and comparative example films on a thickness, respectively material adjusted basis the bending stiffness of the comparative example film is multiplied by a factor of (695 μm/840 μm)³=0.57. Accordingly, for the thickness adjusted bending stiffness of the comparative example film a value of 0.57×141.7 N·mm²=80.26 N·mm² per 1 mm film width is obtained. Thus, the thickness/material adjusted bending stiffness of the inventive film example is 30% larger than that of the comparative polystyrene film.

Similarly, in order to compare the oxygen permeability (OTR) and the water vapor permeability (WVTR) of the inventive and comparative film examples on a thickness/material adjusted basis, the respective values of the comparative film example are multiplied by a factor of 840 μm/695 μm=1.21. Accordingly, for the comparative polystyrene film thickness/material adjusted values of 265.9 cm³/(m²·day·atm) for OTR and 4.59 g/(m²·day) for WVTR are obtained. These values are larger by factors of 35.9 and, respectively 2.9 than the OTR and WVTR of the inventive film example.

The above results show that the inventive film has favorable properties compared to conventional polystyrene film.

Measurement Methods

The physical properties of the inventive film and additives are measured according to the following methods:

TABLE 4
Measurement methods

| Film property | Method |
|---|---|
| Total film thickness | DIN 53370:2006 |
| Layer thickness | Optical and electron microscope imaging |
| | of film section |
| Density | DIN EN ISO 1183:2005 |
| Elastic modulus/ | DIN EN ISO 527:2012 |
| Tensile modulus | |
| Bending stiffness | DIN 53350 |
| | at a bending length of 100 mm using a film |
| | sample with 160 mm length, 30 mm width. |
| Oxygen permeability/ | DIN 53380-3:1998 |
| Oxygen transmission rate | at 23° C. and < 0.1% relative humidity. |
| (OTR) | |
| Water vapor permeability/ | DIN EN ISO 15106-2:2005 |
| Water vapor transmission | at 38° C. and 90% relative humidity. |
| rate (WVTR) | |
| Powder particle size, | Electron microsope imaging of more than |
| equivalent diameter | 1000 particles in combination with |
| | software based image analysis; |
| | Light scattering using Horiba LA-300 laser |
| | diffraction particle size distribution |
| | analyzer for particle sizes from 0.01 to |
| | 5000 μm. |
| Intrinsic viscosity | DIN EN ISO 1628-5:1998 |
| Melt flow rate | DIN EN ISO 1133.2012 |
| | at 190° C. using a load of 2.16 kg and a |
| | standard nozzle having diameter of |
| | 2.095 mm and length of 8 mm. |

In Table 4 and throughout the present invention the term “equivalent diameter” designates the diameter of an “equivalent” spherical particle having the same chemical composition and areal section (electron microscope imaging) or scattering intensity (laser diffraction) as the examined particle. In practice the areal section or scattering intensity of each examined (irregularly shaped) particle is assigned to a spherical particle having a diameter commensurate with the measured signal.

In order to obtain representative values for the density and elastic modulus (tensile modulus) of individual layers of the inventive multilayer film, in particular the first and second layer, homogeneous films i.e. single layer films were prepared from the polymer compound of the respective layer using the same machine settings, such as extruder torque, extruder slit width, extruder slit height and temperature profile as those used for the manufacture of the inventive multilayer film. The density and tensile modulus (elastic modulus) of a single layer film prepared in such manner are then measured according to DIN EN ISO 1183:2005 and, respectively DIN EN ISO 527:2012 and assigned to the layer of an inventive multilayer film prepared from the same compound under the same process conditions.

1. A multilayer polymer film with 2 to 10 layers, comprising
a first layer consisting of 80 to 99.5% by weight of polyester and 0.5 to 20% by weight of additives, based on the total weight of the first layer, said first layer further comprising pores;
a second layer bonded to a first surface of the first layer and consisting of 50 to 90% by weight of polyester and 10 to 50% by weight of additives,
wherein 1 to 30% by weight of a first additive is selected from chalk, talc, mica, wollastonite, calcium carbonate, bentonite, kaolin, clay, titanium oxide and mixtures thereof, based on the total weight of the second layer.

2. The multilayer polymer film according to claim 1, wherein the multilayer polymer film has a thickness of 400 to 1200 μm.

3. The multilayer polymer film according to claim 1, wherein the multilayer polymer film has a density of 1 to 1.4 g/cm³.

4. The multilayer polymer film according to claim 1, wherein the polyester of the first and second layer independently from each other are selected from polyethylene terephthalate and polyesters which consist of (i) 80 to 100 mol-% of a diacid residue component selected from terephthalic acid, naphthalene dicarboxylic acid, 1,4-cyclohexanedicarboxylic acid, isophthalic acid and mixtures thereof and (ii) 80 to 100 mol-% of a diol residue component selected from diols containing 2 to 10 carbon atoms, and mixtures thereof and 0 to 20 mol-% of a modifying diol selected from 1,3-propanediol, 1,4-butanediol, 1,5-pentanediol, 1,6-hexanediol, 1,8-octanediol, 1,4-cyclohexanedimethanol, 2,2,4-trimethyl-1,3-pentanediol, propylene glycol, 2,2,4,4-tetramethyl-1,3-cyclobutanediol, based on 100 mol-% diacid residues and, respectively 100 mol-% diol residues.

5. The multilayer polymer film according to claim 1, wherein the multilayer polymer film has a bending stiffness of 146·t³ to 350·t³ N/mm per 1 mm film width, wherein t is the thickness of the multilayer polymer film in units of mm.

6. The multilayer polymer film according to claim 1, wherein the ratio of thickness T1 of the first layer to thickness T2 of the second layer is in the range from 0.5≤T1/T2≤4.

7. The multilayer polymer film according to claim 1, wherein the first and second layer independently from each other comprise 8 to 24% by weight of polyethylene and 0.1 to 2% by weight of ethylene vinyl acetate, based on the total weight of the first and, respectively the second layer.

8. The multilayer polymer film according to claim 1, wherein the first layer comprises 0.01 to 1% by weight of a foaming agent, based on the total weight of the first layer.

9. The multilayer polymer film according to claim 8, wherein the foaming agent is selected from carbon dioxide, sodium hydrogen carbonate and citric acid, nitrogen, azodicarbonamide, oxy-bis-benzene sulfonylhydrazide, toluene sulfonylhydrazide, benzene sulfonylhydrazide, toluene sulfonylsemicarbazide, 5-phenyltetrazole, di-nitroso pentamethylene tetramine and mixtures thereof.

10. The multilayer polymer film according to claim 1, wherein the multilayer polymer film comprises a third layer bonded to a second surface of the first layer opposite to the second layer, the third layer consisting of 90 to 99.5% by weight of polyester and 0.5 to 10% by weight of additives, based on the total weight of the third layer.

11. The multilayer polymer film according to claim 10, wherein the multilayer polymer film comprises a fourth layer bonded to a surface of the second layer opposite to the first layer, the fourth layer comprising 90 to 99.5% by weight of polyester and 0.5 to 10% by weight of additives, based on the total weight of the fourth layer.

12. The multilayer polymer film according to claim 10, wherein the third layer has a thickness of 4 to 60 μm.

13. The multilayer polymer film according to claim 11, wherein the fourth layer has a thickness of 4 to 60 μm.

14. A multipack comprising 2 to 40 containers thermoformed from the multilayer polymer film according to claim 10 and the first layer or the third layer of the multilayer polymer film constitute an upper surface of the multipack having concave portions.

15. The multipack according to claim 14, wherein the multipack comprises 1 to 40 snap incisions extending from the upper surface of the multipack into the multilayer polymer film to a depth D, wherein D1≤D≤D2, D1 extends to 80% of the thickness of the first layer and D2 extends to 50% of the thickness of the second layer.

16. The multilayer polymer film according to claim 4, wherein the diol containing 2 to 10 carbon atoms is ethylene glycol.
